(19) United States
(12) Patent Application Publication
(10) Pub. No.: US 2011/0008749 A1
(43) Pub. Date: Jan. 13, 2011

(54) Releasing device of addition agent for dental water jet

(76) Inventors: Xiaolin Jin, Chengdu (CN); Longyuan Mei, Lexington, MA (US); Yan Peng, Chongqing (CN); Jinlin Song, Chongqing (CN); Zhenye Mei, Boston, MA (US)

Correspondence Address: Longyu Mei, 31 Gleason Rd., Lexington, MA, 02420, US

(21) Appl. No.: 12/835,255

(22) Filed: Jul. 13, 2010

Related U.S. Application Data
(60) Provisional application No. 61/270,725, filed on Jul. 13, 2009.

(51) Int. Cl. A61C 17/16

(52) U.S. Cl. 433/88

(57) ABSTRACT

This utility model relates to a type of addition agent releasing device used for dental water jet, which is equipped with at least one holding space for releasing addition agents. For example, if the addition agent is toothpaste, each holding space should be equipped with at least one inlet channel entering into the holding space with certain angle, one outlet channel, and without or with at least one water bypass that makes some of the water will not flow into the holding space. The above-mentioned technical solution results in the following technical benefits: 1. The water can spurt into the holding space with addition agent in it at oblique direction and release addition agent evenly; 2. The adjusting device for water flow can adjust flow of the water which flows into the holding space; therefore, it can adjust the time of releasing addition agent; 3. Using addition agent is simple and easy; 4. Small in size, easy to be constructed individually or compounded with other functional parts.

### TECHNICAL FIELDS

This utility model relates to a type of addition agent releasing device used for dental water jet.

### TECHNICAL BACKGROUND

Along with the improvement of life standard, customers' self-care sense in oral hygiene has been enhanced. There are more and more dental hygiene products in market. Dental water jet is just one of them. Dental water jet is used for cleaning teeth and mouth by use of impelling force of water stream generated by water jet device. If addition agent (e.g. toothpaste) can be used with water, the water jet device may have more benefits and better effects. However, so far in market and patent literatures, it is hard to see the design of making use of addition agent (e.g. toothpaste) in dental water jets. There are mainly two types of dental water jets: electrical dental water jet and faucet-mounted dental water jet. The electrical dental water jet is to fill certain amount of water into its water tank, and then the water is to be jet-formed by electrical water pump. The manufacturers mainly include Waterpik (USA) and Tooth Cleaner (China). Although addition agents such as toothpaste etc. can be mixed with water in the water tank, solid toothpaste needs to be stirred for mixing and homogenous; moreover, after addition agents are used, it usually needs to re-fill fresh water into the water tank to wash out addition agent remained in oral cavity. These mixing and refilling make the process cumbersome. Faucet-mounted dental water jet is connected to faucet directly, it generates water jets by taking advantage of the pressure of water supply. Taking Meike Brand Toothflush as an example, which is produced by Chongqing MeiTech, Ltd., in its handle there is an orifice-plate and a cavity. The cavity can be used to hold addition agent such as toothpaste etc. The addition agent will be dissolved in the water and sprayed out when the water flows through this cavity. However, this device may not release addition agent evenly. Sometimes the toothpaste may be washed out in the shape of small blocks within a short time, or sometimes toothpaste may take too long time for dissolving resulting in too low concentration of addition agent in the generated water jets. Chinese Patent 98100670.1 has recorded a type of dental water jet with addition agent releasing device. The addition agent releasing method is to fill addition agent in the container into water channel little by little. This addition agent releasing device has shortcomings including comparatively large container and additional serosity preparation of solid addition agent such as toothpaste etc in advance.

### INTRODUCTION TO UTILITY MODEL

The technical design of this utility model aims to solve the above-mentioned existing technical problems and provide a type of addition agent releasing device used for dental water jet. This addition agent releasing device used for dental water jet is featured by the following advantages: evenly releasing of addition agent, adjustable releasing time of addition agent, convenient application and small volume of components.

In order to solve the above-mentioned technical problems, this utility model adopts the following technical solutions: this type of addition agent releasing device used for dental water jet is equipped with at least one holding space used for holding addition agent; each holding space should be equipped with at least one inlet channel with certain angle and one outlet channel without or with at least one water bypass in which the water shall not flow into the holding space; the holding space and water bypass are connected in parallel.

According to above-mentioned main technical characteristics, the mentioned water bypass is constituted with integral pipelines or apertures; or the mentioned water bypass is a channel formed with joined multiple components.

According to above-mentioned main technical characteristics, at least one water bypass or holding space is equipped with adjusting device which can adjust water flow.

According to above-mentioned main technical characteristics, the mentioned water bypass or holding space is equipped with adjusting device which can adjust water flow. The mentioned adjusting device can act as water switch; the mentioned adjusting device can also act as a device which can extrude water channel to be deformed; the mentioned adjusting device can also act as a device which can block, cut or blot out water channel; the mentioned adjusting device can also act as a device which can change orifice area of water bypass through correspondingly moving components of water bypass which is formed with jointed multiple components.

According to above-mentioned main technical characteristics, the mentioned holding space is a cylinder with a cylinder cover equipped on the upper part which can be opened and closed. The orifice plate with at least one outlet is equipped in the cylinder as cylinder bottom. At least one inlet open to tangent direction of inner periphery of cylinder wall is equipped on cylinder wall.

According to above-mentioned main technical characteristics, the mentioned cylinder-shaped holding space is equipped in a cylinder-shaped hollow which is in the outer shell space; the groove in rotary equipping interface of holding space constitutes a part of water bypass; the orifice area of water bypass can be adjusted.

According to above-mentioned main technical characteristics, the mentioned holding space and the mentioned water bypass can be two separate individual components and can also be jointly manufactured to constitute one integral component with compound function of holding space and water bypass.

According to above-mentioned main technical characteristics, the mentioned holding space can be a separate individual functional component and can also be jointly manufactured with other functional components.

This utility model has the following beneficial effects: 1. the water can spurt into the holding space with addition agent in it at oblique direction and release addition agent (e.g. toothpaste) evenly; 2. The adjusting device for water flow can adjust flow of the water that flows into the holding space; therefore, it can adjust the time of releasing addition agent; 3. It needs no further process for making of serosity after adding addition agent, thus the process is very convenient when using addition agent; 4. It is small in size, and therefore easy to be used directly as an individual component or to be compounded with other functional components to form a multifunctional part. More detailed description of technical solutions for this utility model will be given integrating with attached drawings and working examples.

### INTRODUCTION TO ATTACHED FIGURES

FIG. 1 is the stereoscopic sketch of cleaning device for tooth and oral cavity in this utility model;

FIG. 2 is the vertical view of a compound functional component which is jointly manufactured for water jacket and addition agent releasing device in a working example of this utility model. The holding space for this addition agent releasing device has not been equipped;

FIG. 3 is the sketch of A-A section in FIG. 2;

FIG. 4 is the vertical view of holding space of the mentioned compound functional component which has not been displayed in FIG. 2;

FIG. 5 is the sketch map of B-B section in FIG. 4.

### SPECIFIC WORKING EXAMPLES

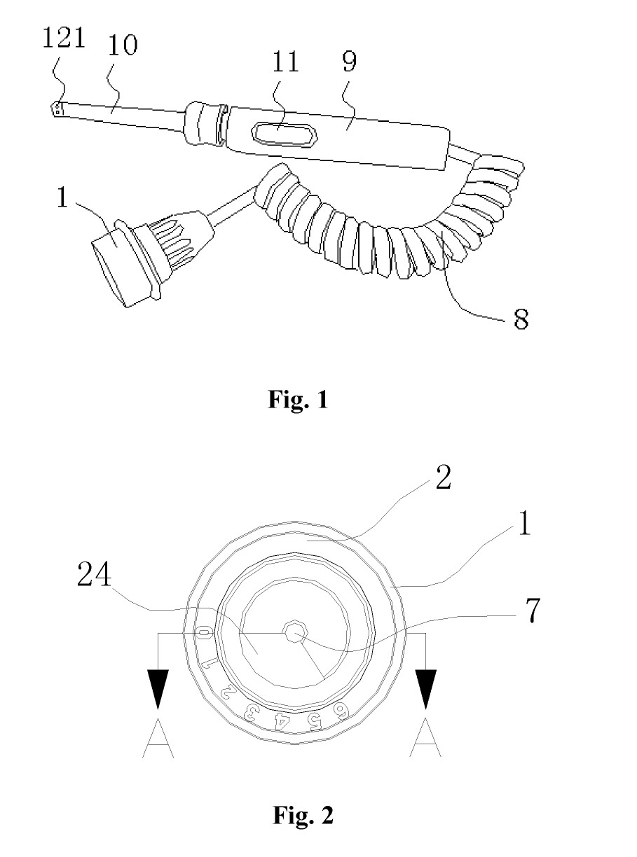

Referring to illustration from FIG. 1 to FIG. 5, an introduction to a type of addition agent releasing device used for dental water jet in this utility model will be given as following specific working examples.

The mentioned addition agent releasing device is equipped with at least one holding space used for holding addition agent; each holding space shall be equipped with at least one inlet channel with certain angle and one outlet channel; the mentioned addition agent releasing device shall also be equipped with at least one water bypass in which the water flows through and shall not flow into the holding space; the holding space and water bypass are connected in parallel. The mentioned addition agent releasing device can also be designed without any water bypass.

The mentioned water bypass is constituted with integral pipelines or apertures; or the mentioned water bypass is a channel formed with joined multiple components. At least one water bypass or holding space is equipped with adjusting device which can adjust water flow; the mentioned adjusting device can act as water switch; the adjusting device can also act as a device which can extrude water channel to be deformed; the adjusting device can also act as a device which can block, cut or blot out water channel; the adjusting device can also act as a device which can change orifice area of water bypass through correspondingly moving components that form the water bypass. The mentioned holding space is a cylinder with a cylinder cover equipped on the upper part which can be opened and closed. The orifice plate with at least one outlet is equipped in the cylinder as cylinder bottom. At least one inlet open to tangent direction of inner periphery of cylinder wall is equipped on cylinder wall.

The mentioned cylinder-shaped holding space is equipped in a cylinder-shaped hollow which is in the outer shell space; the grooves for the two components on equipping interface constitute a part of water bypass; the mentioned grooves can be on the two components or any single component. The two components can move relative to each other; therefore, the orifice area of water bypass formed with the two components is adjustable. The mentioned holding space and the mentioned water bypass can be two separate individual components, integrated to constitute the mentioned addition agent releasing device; the mentioned holding space and the mentioned water bypass can also be jointly manufactured with other components to form a compound functional component. This addition agent releasing device can be an separate individual functional component to be equipped in dental water jet system; or it can also be jointly manufactured for use together with other functional components of dental water jet.

As illustrated in FIG. 1, the water jacket 1 with compound functions of water inlet and addition agent releasing shall conduct the water from faucet into water transportation soft tube 8; the water continues to flow through handle 9 and nozzle 10, and shall be sprayed out from nozzle 121 to clean teeth and oral cavity. Switch 11 is equipped on handle 9.

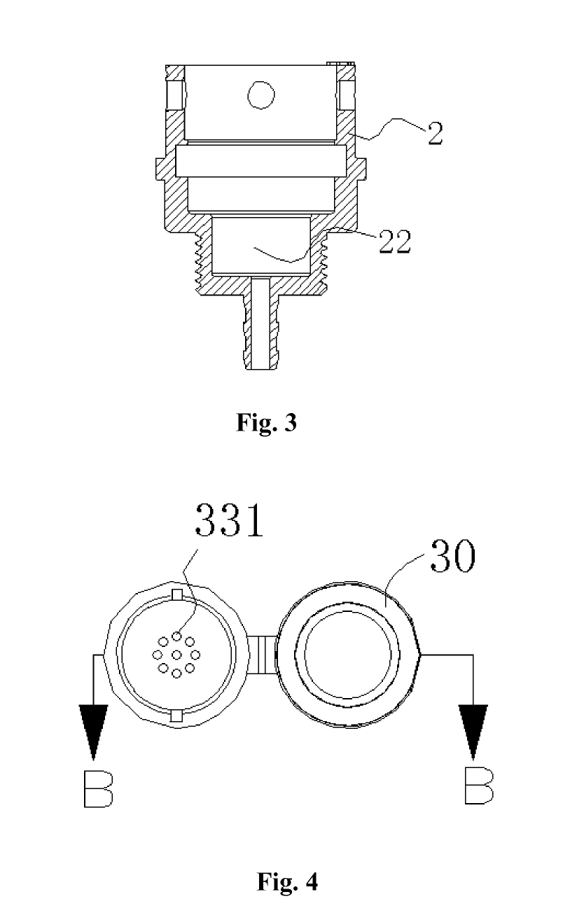

As illustrated in FIG. 2 and FIG. 3, due to compound manufacture of water inlet device and addition agent releasing device, the components are featured by the following main structural characteristics: it is constituted by two cylinders with different sizes at upper and lower parts. The space 22 in small cylinder at lower part is used to equip holding space for addition agent releasing device; the space in large cylinder enclosed with large cylinder wall 2 is used to connect faucet for obtaining water and holding a part of holding space in addition agent releasing device which is higher than the space 22 in small cylinder. The small sector area 24 at the bottom of small cylinder space 22 is a groove lower than corresponding large sector area. It is used to equip holding space of addition agent releasing device and ensure the downward water from the groove on outer wall of the holding space can flow into outlet 7 through it. There are marks of 0-6 on top edge of large cylinder wall 2 which are used to indicate corresponding positions of grooves on outer wall of holding space in addition agent releasing device equipped in small cylinder space 22.

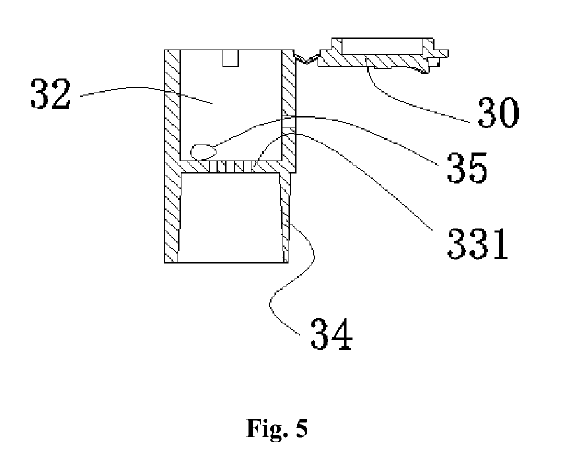

As illustrated in FIG. 4 and FIG. 5, the mentioned holding space is a cylinder with cover. The lower part of holding space will be quipped into small cylinder space 22. On equipping interface, there is groove 34 on outer surface of holding space whose height is larger than the depth of cylinder space 22. This groove 34 and the wall of small cylinder space 22 are connected to form water channel. When vertical groove 34 is aligned to the lower small sector area 24, the formed water channel is the largest; when rotating holding space to certain angle and overlapping vertical groove 34 with small sector area 24 for just a small part, the water channel formed by joining overlap turns narrower; when holding space is rotated to specific position and the connection of the bottom of vertical groove 34 to small sector area 24 is cut even completely blocked by the bottom, there is no water channel. There is oblique hole 35 on cylinder wall which is higher than the equipping depth used for the holding space equipped in small cylinder space 22. This oblique hole 35 is open to the cylinder at the tangent direction of cylinder's inner periphery and is higher than orifice plate 331 in the cylinder. There is at least one hole in orifice plate 331.

Therefore, the working principle of this addition agent releasing device goes as follows: when addition agent releasing device is connected to faucet, the water in faucet flows into the space formed by the large cylinder wall 2 and the part of holding space which is beyond equipping depth. The water flowing into this space will be divided into two parts, flow out through two channels and join together again at outlet 7 for going out: one part of water will go into holding space through oblique hole in holding space and dissolve & release toothpaste gradually which is between orifice plate and cylinder cover in holding space cylinder; And then toothpaste flows downwards from orifice plate and goes out through 7 along with water. The other part of water will not go into holding space. It goes through vertical groove 34 and into small sector area 24 and flows out via outlet 7. Since overlap area of vertical groove 34 and small sector area 24 is adjustable, water flow in holding space can be adjusted indirectly, and then the dissolving and releasing speed of toothpaste can be adjusted. To use the addition agent releasing device, open cover 30, fill certain amount of toothpaste into holding space 32, close cover 30 and then get water for using.

The holding space and water bypass of addition agent releasing device can be jointly manufactured to be a compound component, and can also act as two individual components for separate or compound applications.

The addition agent releasing device can be jointly manufactured to be a compound component together with other functional components; the addition agent releasing device can also act as an individual component and be equipped in any position of dental water jet for usage.

Generally speaking, 1. The water can spurt into the holding space with addition agent in it at oblique direction and release addition agent evenly (e.g. toothpaste); 2. The adjusting device for water flow can adjust flow of the water directly or indirectly which flows into the holding space; therefore, it can adjust the releasing time of addition agent; 3. It needs no further process for making of even serosity after adding addition agent, thus the process is very convenient when using addition agent; 4. Since the addition agent releasing device is small, it is convenient for direct use as an individual component or being manufactured with other functional components to form a compounded multifunctional component.

1. A type of addition agent releasing device used for dental water jet, which is featured by:
1) it is equipped with at least one holding space used for containing addition agent, 2) each holding space has at least one inlet channel which lets water entering into the holding space at certain angle, and has at least one water outlet, 3) there is zero or at least one water bypass that lets some of water not go into the holding space, 4) the holding space and water bypass are connected in parallel.
The addition agent releasing device which is used for dental water jet and mentioned according to claim 1, is featured by: the mentioned water bypass is constituted with pipelines or apertures; or the mentioned water bypass is a gap or channel formed between or among joined multiple components.
The addition agent releasing device which is used for dental water jet and mentioned according to claim 1 or 2, is featured by: at least one water bypass or holding space is equipped with adjusting device which can adjust water flow.
The addition agent releasing device which is used for dental water jet and mentioned according to claim 3, is featured by: the mentioned water bypass or holding space is equipped with water adjusting device which can adjust water flow. The mentioned water adjusting device can be a valve; the mentioned water adjusting device can be a device which can deform water channel therefore get the water flow rate changed; the mentioned water adjusting device can be a device which can block, cut or hide water channel; the mentioned adjusting device can also be a device which can move at least one of the jointed multiple components that form the gap or channel for water to flow.
The addition agent releasing device which is used for dental water jet and mentioned according to claim 1, is featured by: the mentioned holding space is a cylinder with a cylinder cover equipped on the upper part which can be opened and closed. An orifice plate with at least one outlet is equipped in the cylinder as cylinder bottom. At least one inlet open to tangent direction of inner periphery of cylinder wall is equipped on cylinder wall.
The addition agent releasing device which is used for dental water jet and mentioned according to claim 5, is featured by: the mentioned cylinder-shaped holding space is placed in a cylinder-shaped hollow of a outer shell; there is at least one groove or dent on the contacting surfaces of the holding space and/or the outer shell, and the groove or dent constitutes a part of water bypass; the holding space in the outer shell can be turned around, and the flow rate of the water bypass can be adjusted.
The addition agent releasing device which is used for dental water jet and mentioned according to claim 1, is featured by: the mentioned holding space and the mentioned water bypass can be two individually independent components, and can also be jointly manufactured to constitute a single integrated component with compound function of holding space and water bypass.
The addition agent releasing device which is used for dental water jet and mentioned according to claim 1, is featured by: the mentioned addition agent releasing device can be a single independent component, and can also be compounded with other components to form a multi-functional single component.
